(19) United States
(12) Patent Application Publication
(10) Pub. No.: US 2021/0304121 A1
(43) Pub. Date: Sep. 30, 2021

(54) COMPUTERIZED SYSTEMS AND METHODS FOR PRODUCT INTEGRATION AND DEDUPLICATION USING ARTIFICIAL INTELLIGENCE

(71) Applicant: Coupang Corp., Seoul (KR)

(72) Inventors: Gil Ho LEE, Shanghai (CN); Qidong Tang, Shanghai (CN); Anan Hu, Shanghai (CN)

(73) Assignee: Coupang, Corp.

(21) Appl. No.: 16/834,051

(22) Filed: Mar. 30, 2020

(51) Int. Cl. G06Q 10/08; G06F 16/215; G06F 16/958; G06N 20/00; G06N 5/04; G06F 40/284; G06F 40/232

(52) U.S. Cl. CPC G06Q 10/087; G06F 16/215; G06F 16/958; G06F 40/232; G06N 5/04; G06F 40/284; G06N 20/00

(57) ABSTRACT

Systems and methods are provided for integrating and deduplicating products using Al. One method comprises receiving at least one request to register a first product; searching at least one data store for a second product; tagging, using a machine learning model, at least one keyword from product information associated with the first product and tagging at least one keyword from product information associated with the second product; determining, using the machine learning model, a match score between the first product and the second product; when the match score is above a first predetermined threshold, determining, using the machine learning model, that the first product is identical to the second product; and when the match score is below a first predetermined threshold, determining, using the machine learning model, that the first product is not the second product.

### TECHNICAL FIELD

The present disclosure generally relates to computerized systems and methods for product integration and deduplication using artificial intelligence. In particular, embodiments of the present disclosure relate to inventive and unconventional systems relate to receiving product information associated with a first product, collecting product information associated with a second product, determining a match score between the first product and the second product, determining whether or not the first and second products are identical based on the match score, integrating and deduplicating the first and second products based on the determination, and registering the first product.

### BACKGROUND

Consumers often shop for and purchase various items online through computers and smart devices. These online shoppers often use search engines to find products to purchase. However, the normal online shopping experience is hindered by search result webpages displaying the same product multiple times as distinct products.

Millions of products are registered online by sellers every day. Sellers are required to correctly label their product when registering their products online for sale. However, many different sellers accidentally or intentionally label their products with irrelevant words or unique phrases so that their products are registered as products that are distinct from other sellers. For example, a first seller may label their product as “Limited Edition” while a second seller may label the same product as “Limited Sale.” Product registration systems that are unable to identify the two products as identical products may severely reduce a consumer's user experience by prolonging the consumer's product search and by reducing the recommendation quality of the online platform. Furthermore, manually integrating and deduplicating products is often difficult and time-consuming since millions of products are registered every day. A consumer's user experience would be significantly improved if the online platform automatically deduplicated and integrated identical products into a single search result, allowing sellers of the same product to compete for the “best seller” recommended for the listed product.

Therefore, there is a need for improved methods and systems for product integration and deduplication so that consumers may quickly find and purchase products while online shopping.

### SUMMARY

One aspect of the present disclosure is directed to a computer-implemented system for Al-based product integration and deduplication. The system may comprise at least one processor; and at least one non-transitory storage medium comprising instructions that, when executed by the at least one processor, cause the at least one processor to perform steps. The steps may comprise receiving at least one request to register a first product; receiving product information associated with the first product; searching at least one data store for a second product; collecting, using a machine learning model, product information associated with the second product; tagging, using the machine learning model, at least one keyword from the product information associated with the first product and tagging at least one keyword from the product information associated with the second product; determining, using the machine learning model, a match score between the first product and the second product, by using the tagged keywords associated with the first product and the second product; when the match score is above a first predetermined threshold, determining, using the machine learning model, that the first product is identical to the second product and modifying the at least one data store to include data indicating that the first product is identical to the second product; when the match score is below a first predetermined threshold, determining, using the machine learning model, that the first product is not the second product and modifying the at least one data store to include data indicating that the first product is not the second product; registering the first product; and modifying a webpage to include registration of the first product.

Another aspect of the present disclosure is directed to a method for integrating and deduplicating products using Al. The method may comprise receiving at least one request to register a first product; receiving product information associated with the first product; searching at least one data store for a second product; collecting, using a machine learning model, product information associated with the second product; tagging, using the machine learning model, at least one keyword from the product information associated with the first product and tagging at least one keyword from the product information associated with the second product; determining, using the machine learning model, a match score between the first product and the second product, by using the tagged keywords associated with the first product and the second product; when the match score is above a first predetermined threshold, determining, using the machine learning model, that the first product is identical to the second product and modifying the at least one data store to include data indicating that the first product is identical to the second product; when the match score is below a first predetermined threshold, determining, using the machine learning model, that the first product is not the second product and modifying the at least one data store to include data indicating that the first product is not the second product; registering the first product; and modifying a webpage to include registration of the first product.

Yet another aspect of the present disclosure is directed to a computer-implemented system for Al-based product integration and deduplication. The system may comprise at least one processor; and at least one non-transitory storage medium comprising instructions that, when executed by the at least one processor, cause the at least one processor to perform steps. The steps may comprise receiving at least one request to register a first product; receiving product information associated with the first product; searching at least one data store for a second product; collecting, using a first machine learning model, product information associated with the second product; tagging, using the first machine learning model, at least one keyword from the product information associated with the first product and tagging at least one keyword from the product information associated with the second product; determining, using the first machine learning model, a match score between the first product and the second product, by using the tagged keywords associated with the first product and the second product; when the match score is above a first predetermined threshold, determining, using the first machine model, that the first product is identical to the second product and modifying the at least one data store to include data indicating that the first product is identical to the second product; when the match score is below a first predetermined threshold, determining, using the first machine model, that the first product is not the second product and modifying the at least one data store to include data indicating that the first product is not the second product; registering the first product; and modifying a webpage to include registration of the first product. The steps may further comprise collecting, using a second machine learning model, product information associated with a plurality of third products; tagging, using the second machine learning model, a plurality of keywords from product information associated with the plurality of third products; determining, using the second machine learning model, a plurality of second match scores between the plurality of third products, by using the tagged keywords associated with the plurality of third products; when any one of the plurality of second match scores is above the first predetermined threshold, determining, using the second machine learning model, that the third products associated with the second match score are identical and deduplicating the identical third products; and modifying the webpage to include deduplication of the identical third products.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 depicts a sample SRP that includes one or more search results generated without a product integration and deduplication system, consistent with the disclosed embodiments.

FIG. 4 is a schematic block diagram illustrating an exemplary embodiment of a network comprising computerized systems for Al-based product integration and deduplication, consistent with the disclosed embodiments.

FIG. 5 is a schematic block diagram illustrating an exemplary embodiment of a network comprising computerized systems for Al-based product integration and deduplication, consistent with the disclosed embodiments.

FIG. 6 is a process illustrating an exemplary embodiment of candidate search systems for Al-based product integration and deduplication, consistent with the disclosed embodiments.

FIG. 7 is a process illustrating an exemplary embodiment of category prediction system for Al-based product integration and deduplication, consistent with the disclosed embodiments.

FIG. 8A is a process illustrating an exemplary embodiment of category prediction system for Al-based product integration and deduplication, consistent with the disclosed embodiments.

FIG. 8B is a process illustrating an exemplary embodiment of calculating token vectors for Al-based product integration and deduplication, consistent with the disclosed embodiments.

FIGS. 8CA-8F are processes illustrating exemplary embodiments of consolidating features into one vector for Al-based product integration and deduplication, consistent with the disclosed embodiments.

FIG. 9 depicts sample tagged data for Al-based product integration and deduplication, consistent with the disclosed embodiments.

FIG. 10 depicts a process for integrating and deduplicating products using Al, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for product integration and deduplication using Al. The disclosed embodiments are advantageously capable of automatically integrating and deduplicating products in real-time online and with large quantities of products offline. For example, an online matching system may receive a new request to register a first product from user (e.g., a seller) via user device. The new request may include product information data (e.g., product identification number, category identification, product name, product image URL, product brand, product description, manufacturer, vendor, attributes, model number, barcode, etc.) associated with the first product to be registered. The online matching system may search a database for a second product using keywords from the product information data associated with the first product. In some embodiments, the online matching system may use a search engine (e.g., Elasticsearch) to search an inverted index of database containing keywords, phrases, positions of keywords in phrases, etc. given keywords of the first product.

In some implementations, the online matching system may use a machine learning model to determine a match score between the first product and each of the second products. The match score may be calculated using the tagged keywords associated with the first product and the second products. The match score may be calculated using any combination of methods (e.g., Elasticsearch, Jaccard, naïve Bayes, W-CODE, ISBN, etc.). For example, the match score may be calculated by measuring the spelling similarities between the keywords of the first product and the keywords of the second product. In some embodiments, the match score may be calculated based on the number of shared keywords between the first product and the second product. The machine learning model of the online matching system may determine that the first product is identical to one of the second products when the match score is above a predetermined threshold (e.g., the second product with the highest match score and a minimum number of matching attributes, the second product associated with the highest match score, the second product with the highest match score and a price within a certain price range, etc.). The machine learning model may then modify the database to include data indicating that the first product is identical to the second product, thereby merging the products into a single listing and preventing product duplication. The machine learning model may determine that the first product is not any of the second products when the match scores do not meet a predetermined threshold. The machine learning model may then modify database to include data indicating that the first product is not any of the second products, thereby listing the first product as a distinct new listing.

In some embodiments, an offline matching system may operate when the online matching system is not operating. For example, the offline matching system may operate periodically (e.g., daily) and independently of the online matching system. The online matching system may operate under a time constraint (e.g., 15 minutes) so that sellers may register new products without delay. The offline matching system may operate without time constraints, so match scores may be calculated for a first batch of a plurality of products and a second batch of a plurality of products. The offline matching system may use more expensive calculation logic (e.g., gradient boosting, convolutional neural network, etc.) since it may operate without time constraints. Similar to the online matching system, the offline matching system may use a machine learning model to tag a plurality of keywords from product information associated with the first and second batches of products and determine a plurality of match scores between any combination of the first and second batches of products. The match scores may be determined by using the tagged keywords. The machine learning model may determine that products associated with a match score are identical when the match score is above a predetermined threshold. The machine learning model may remove a first identical product from its associated listing and add that first identical product to a listing associated with a second identical product in order to integrate and deduplicate the products.

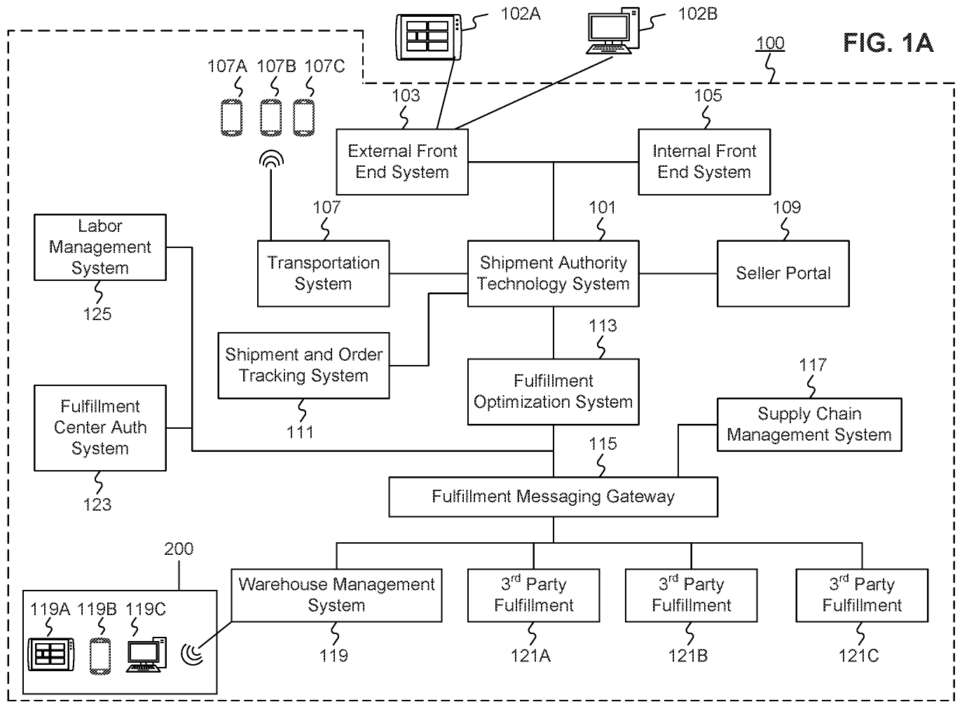

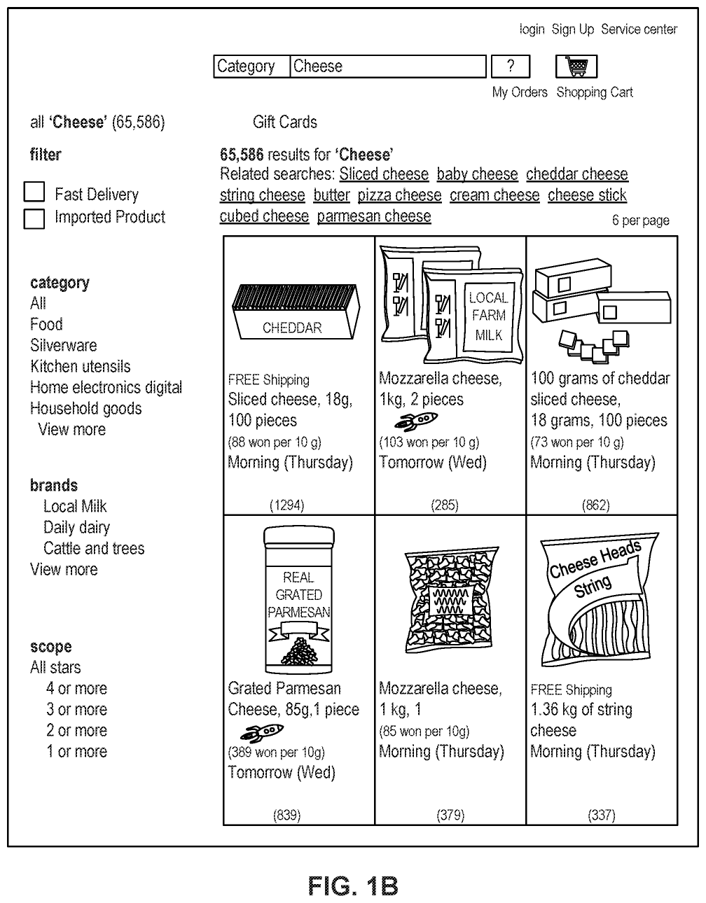

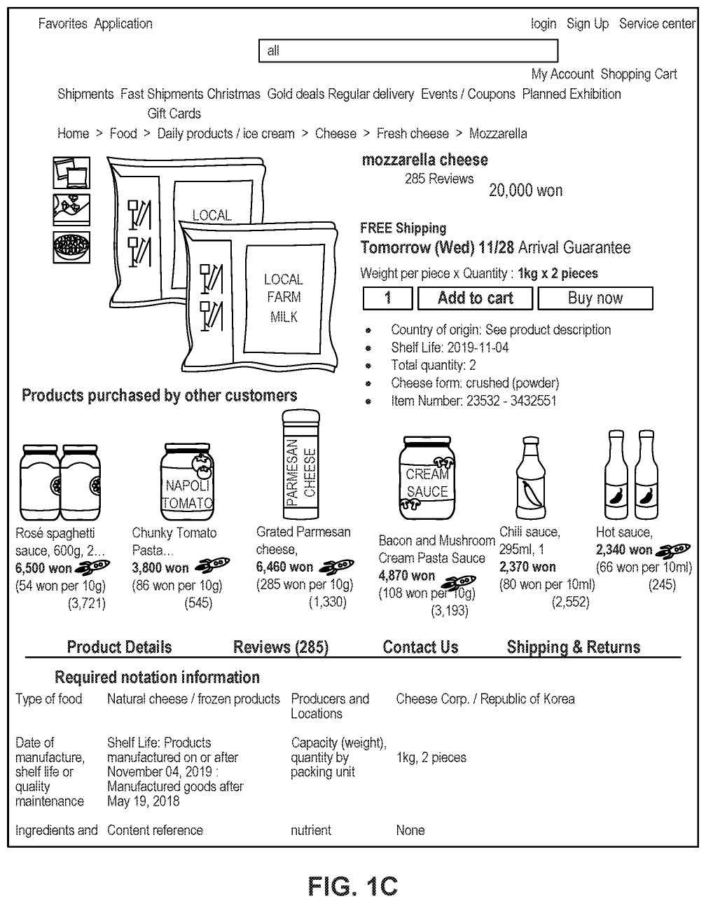

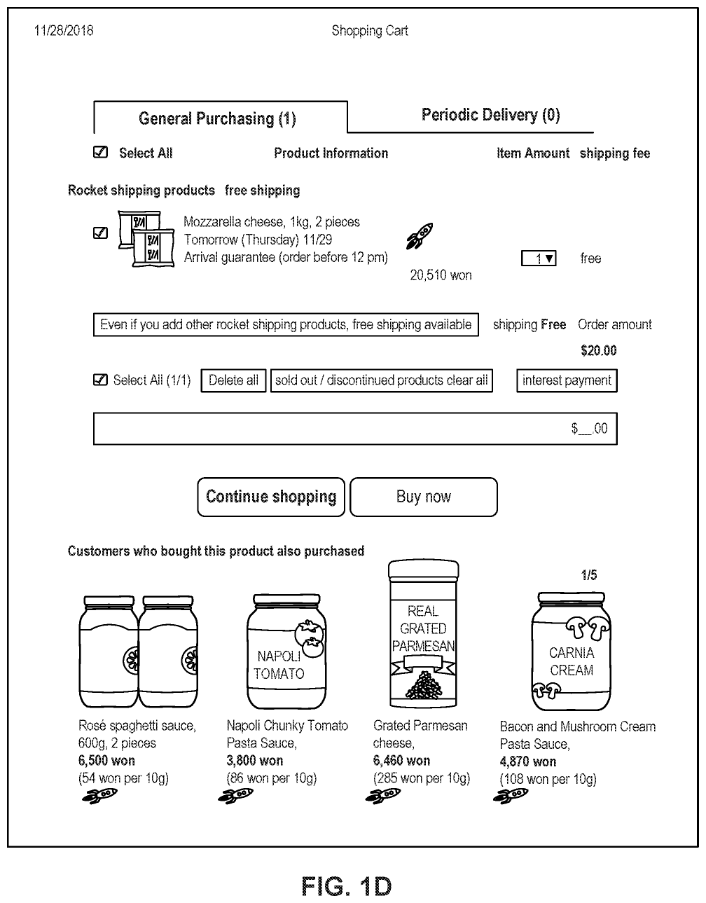

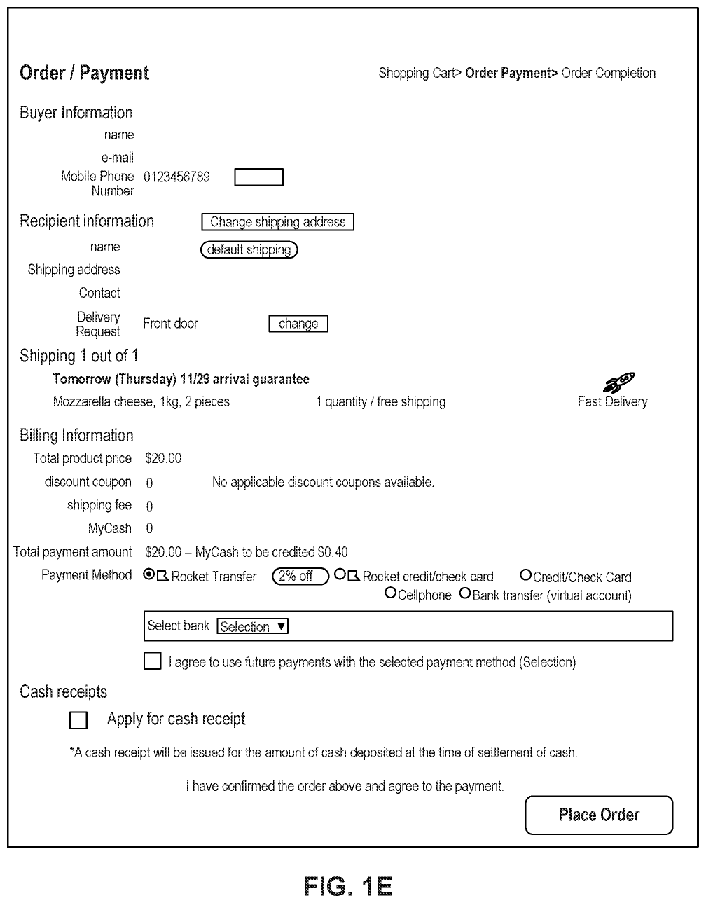

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3rd party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3rd party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

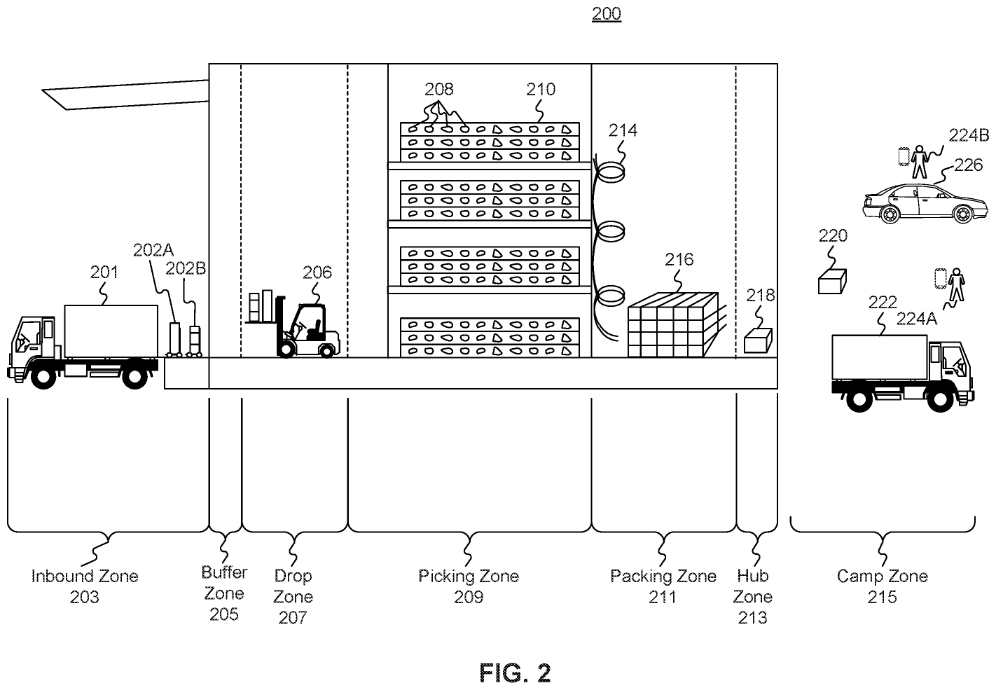

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1196, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1196.

Once a user places an order, a picker may receive an instruction on device 1196 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 2246.

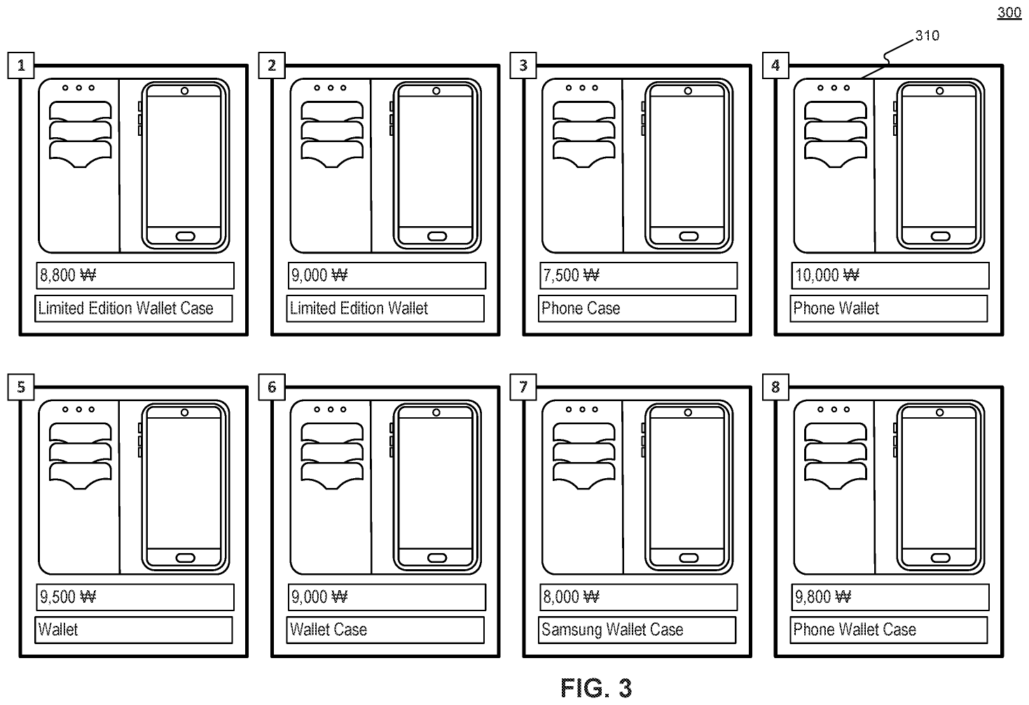

Referring to FIG. 3, a sample SRP 300 that includes one or more search results generated without a product integration and deduplication system is shown. For example, a product 310 may be sold by eight different sellers and SRP 300 may display eight distinct product results for the same product 310. Using the disclosed embodiments, product 310 may be integrated into a single product result that recommends the best seller.

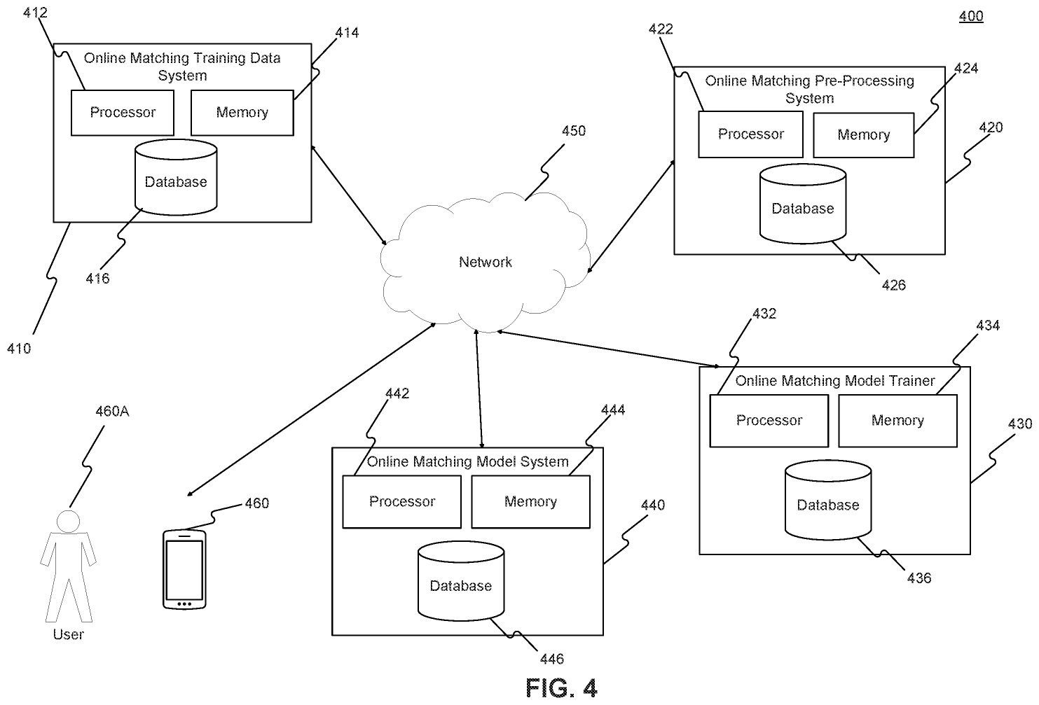

Referring to FIG. 4, a schematic block diagram illustrating an exemplary embodiment of a network comprising computerized systems for Al-based product integration and deduplication is shown. As illustrated in FIG. 4, a system 400 may include an online matching training data system 410, an online matching pre-processing system 420, an online matching model trainer 430, and an online matching model system 440, each of which may communicate with a user device 460 associated with a user 460A via a network 450. A system may operate online when it operates concurrently with one or more sellers who are registering their product. In some embodiments, online matching training data system 410, online matching pre-processing system 420, online matching model trainer 430, and online matching model system 440 may communicate with each other and with the other components of system 400 via a direct connection, for example, using a cable. In some other embodiments, system 400 may be a part of system 100 of FIG. 1A and may communicate with the other components of system 100 (e.g., external front end system 103 or internal front end system 105) via network 450 or via a direct connection, for example, using a cable. Online matching training data system 410, online matching pre-processing system 420, online matching model trainer 430, and online matching model system 440 may each comprise a single computer or may each be configured as a distributed computer system including multiple computers that interoperate to perform one or more of the processes and functionalities associated with the disclosed examples.

As shown in FIG. 4, online matching training data system 410 may comprise a processor 412, a memory 414, and a database 416. Online matching pre-processing system 420 may comprise a processor 422, a memory 424, and a database 426. Online matching model trainer system 430 may comprise a processor 432, a memory 434, and a database 436. Online matching model system 440 may comprise a processor 442, a memory 444, and a database 446. Processors 412, 422, 432, and 442 may be one or more known processing devices, such as a microprocessor from the Pentium™ family manufactured by Intel™ or the Turion™ family manufactured by AMD™. Processors 412, 422, 432, and 442 may constitute a single core or multiple core processor that executes parallel processes simultaneously. For example, processors 412, 422, 432, and 442 may use logical processors to simultaneously execute and control multiple processes. Processors 412, 422, 432, and 442 may implement virtual machine technologies or other known technologies to provide the ability to execute, control, run, manipulate, store, etc. multiple software processes, applications, programs, etc. In another example, processors 412, 422, 432, and 442 may include a multiple-core processor arrangement configured to provide parallel processing functionalities to allow online matching training data system 410, online matching pre-processing system 420, online matching model trainer system 430, and online matching model system 440 to execute multiple processes simultaneously. One of ordinary skill in the art would understand that other types of processor arrangements could be implemented that provide for the capabilities disclosed herein.

Memories 414, 424, 434, and 444 may store one or more operating systems that perform known operating system functions when executed by processors 412, 422, 432, and 442, respectively. By way of example, the operating system may include Microsoft Windows, Unix, Linux, Android, Mac OS, iOS, or other types of operating systems. Accordingly, examples of the disclosed invention may operate and function with computer systems running any type of operating system. Memories 414, 424, 434, and 444 may be a volatile or non-volatile, magnetic, semiconductor, tape, optical, removable, non-removable, or other type of storage device or tangible computer readable medium.

Databases 416, 426, 436, and 446 may include, for example, Oracle™ databases, Sybase™ databases, or other relational databases or non-relational databases, such as Hadoop™ sequence files, HBase™, or Cassandra™. Databases 516, 526, and 536 may include computing components (e.g., database management system, database server, etc.) configured to receive and process requests for data stored in memory devices of the database(s) and to provide data from the database(s). Databases 416, 426, 436, and 446 may include NoSQL databases such as HBase, MongoDB™ or Cassandra™. Alternatively, databases 416, 426, 436, and 446 may include relational databases such as Oracle, MySQL and Microsoft SQL Server. In some embodiments, databases 416, 426, 436, and 446 may take the form of servers, general purpose computers, mainframe computers, or any combination of these components.

Databases 416, 426, 436, and 446 may store data that may be used by processors 412, 422, 432, and 442, respectively, for performing methods and processes associated with disclosed examples. Databases 416, 426, 436, and 446 may be located in online training data system 410, online pre-processing system 420, online matching model trainer system 430, and online matching model system 440, respectively, as shown in FIG. 4, or alternatively, it may be in an external storage device located outside of online training data system 410, online pre-processing system 420, online matching model trainer system 430, and online matching model system 440. Data stored in 416 may include any suitable online matching training data associated with products (e.g., product identification number, category identification, product name, product image URL, product brand, product description, manufacturer, vendor, attributes, model number, barcode, highest category level, category sublevels, etc.), data stored in 426 may include any suitable data associated with online matching pre-processed training data, data stored in 436 may include any suitable data associated with training the online matching model, and data stored in 446 may include any suitable data associated with match scores of different pairs of products.

User device 460 may be a tablet, mobile device, computer, or the like. User device 460 may include a display. The display may include, for example, liquid crystal displays (LCD), light emitting diode screens (LED), organic light emitting diode screens (OLED), a touch screen, and other known display devices. The display may show various information to a user. For example, it may display an online platform for entering or generating training data, including an input text box for internal users (e.g., employees of an organization that owns, operates, or leases system 100) or external users to enter training data or product information data, including product information (e.g., product identification number, highest category level, category sublevels, product name, product image, product brand, product description, etc.). User device 460 may include one or more input/output (I/O) devices. The I/O devices may include one or more devices that allow user device 460 to send and receive information from user 460A or another device. The I/O devices may include various input/output devices, a camera, a microphone, a keyboard, a mouse-type device, a gesture sensor, an action sensor, a physical button, an oratory input, etc. The I/O devices may also include one or more communication modules (not shown) for sending and receiving information from online matching training data system 410, online matching pre-processing system 420, online matching model trainer system 430, or online matching model system 440 by, for example, establishing wired or wireless connectivity between user device 460 and network 450.

Online matching training data system 410 may receive initial training data including product information associated with one or more products. Online matching training data system 410 may collect training data by human labeling pairs of products. For example, user 460A may compare the product information (e.g., product category, name, brand, model no., etc.) of a first product to the product information of a second product, determine whether or not the pair of products are identical, and label the pair of products as “match” if the products are identical or “different” if the products are not identical. Users (e.g., user 460A) may periodically (e.g., daily) sample pairs of products to label the pairs as “match” or “different,” thereby providing training data to online matching training data system 410.

Online matching pre-processing system 420 may receive the initial training data collected by online matching training data system 410 and generate synthesized training data by pre-processing the initial training data. Online matching pre-processing system 420 may tag the keywords from a pair of products. Tagging the keywords may include extracting the keywords and filtering the extracted keywords based on predetermined conditions. For example, online matching pre-processing system 420 may extract keywords from the product information associated with the first and second products of a pair and, according to a predetermined condition to filter out keywords associated with brand names, store the keywords of the first and second products excluding the brand names. Online matching pre-processing system 420 may tokenize keywords by referencing a token dictionary stored in database 426 and implementing an Aho-Corasick algorithm to determine whether or not to split a keyword into multiple keywords. For example, keywords written in certain languages (such as Korean) may be stored as a single string of text without spaces. (A fluent speaker would understand that this string of text may be split into various combinations of words.) Online matching pre-processing system 420 may implement an Aho-Corasick algorithm, which is a dictionary-matching algorithm that locates elements of a finite set of strings (e.g., the “dictionary”) within text associated with the first and second products. The algorithm matches all the strings simultaneously so that online matching pre-processing system 420 may extract keywords by collecting the actual keywords of the text while removing “split” words that are not listed in the stored dictionary. Keyword tokenization may increase product integration and deduplication by removing superfluous words that slow down the machine learning model.

Online matching model trainer 430 may receive the synthesized training data generated from online matching pre-processing system 420. Online matching model trainer 430 may generate and train at least one online matching model using the received synthesized data for product matching. For example, a model may be generated for each higher level product category. Each model may be a Naïve Bayes model that may be trained to determine the likelihood that a pair of products are identical based on the product information of the pair. Online matching model trainer 430 may assume that each product characteristic is independent of each other and use the received synthesized training data to calculate match scores using the following formula:

$$p ( y = 1 \vert x ) = \frac{p ( x \vert y = 1 ) p ( y = 1 )}{p ( x )} = \\ \frac{( {\prod }_{i = 1}^{n} p ( {x}_{i} \vert y = 1 ) ) p ( y = 1 )}{\begin{matrix}( {\prod }_{i = 1}^{n} p ( {x}_{i} \vert y = 1 ) ) p ( y = 1 ) + ( {\prod }_{i = 1}^{n} p ( {x}_{i} \vert y = 0 ) ) {p ( y = 0 )}^{′} \\ \end{matrix}} \qquad Equation ( 1 )$$

Using the synthesized training data may be advantageous in that both tagged characteristics of a pair of products (e.g., color, size, brand, etc.) and tokenized keywords of a pair of products (e.g., XL, red, black, etc.) may be used to calculate match scores for pairs of products and automatically merge identical products.

For example, the synthesized training data may include 10,000 pairs of products. Sixty percent of the synthesized training data may be “matched” pairs of products while forty percent of the synthesized training data may be “different” pairs of products. Eighty-three percent of the “matched” pairs may have the same color while fifty percent of the “different” pairs may have the same color. Online matching model trainer 430 may calculate the probability of a pair of products being identical when they have the same color using Equation (1) as follows:

$$p ( Match \vert Color ) = \frac{p ( Color \vert Match ) p ( Match )}{p ( Color )} = \frac{0.83 •0 .60}{0.83 •0 .60 + 0.50 •0 .40} = 71 \%$$

Online matching model trainer 430 may calculate the probability of a pair of products being identical when they share a plurality of product information using Equation (1) for any of the synthesized training data.

Online matching model system 440 may perform operations in real-time when registering products for sellers. For example, online matching model system 440 may receive a new request to register a first product from user 460A (e.g., a seller) via user device 460. The new request may include product information data (e.g., product identification number, category identification, product name, product image URL, product brand, product description, manufacturer, vendor, attributes, model number, barcode, etc.) associated with the first product to be registered. Online matching model system 440 may search database 446 for a second product using keywords from the product information data associated with the first product. For example, online matching model system 440 may use a search engine (e.g., Elasticsearch) to search an inverted index of database 446 containing keywords, phrases, positions of keywords in phrases, etc. given keywords of the first product. The inverted index may include a list of all the keywords, phrases, positions of keywords in phrases, etc. that may appear in any product information and for each keyword, phrase, position of keywords in phrases, etc., a list of the products in which it appears. Online matching model system 440 may process the keywords of the first product using any combination of methods. For example, online matching model system 440 may perform a stemming process on each keyword by reducing each keyword to its root word. For example, the words “rain,” “raining,” and “rainfall” have the common root word “rain.” When the keyword is indexed, the root word is stored into the index, thereby increasing the search relevance of the keywords. The keywords stored in database 446 are indexed stemmed keywords. Additionally, online matching model system 440 may perform a synonym search on each keyword, thereby improving the keyword search quality.

Online matching model system 440 may use a machine learning model trained by online matching model trainer 430 to determine that at least one second product (e.g., 100 second products) in database 446 may be similar to the first product based on shared or similar keywords of the first and second products. The machine learning model of online matching model system 440 may collect product information (e.g., product identification number, category identification, product name, product image URL, product brand, product description, manufacturer, vendor, attributes, model number, barcode, etc.) associated with the at least one second product. The second products in database 446 may be products that are currently registered with at least one seller.

The machine learning model may then tag the keywords from the first and second products. Tagging the keywords may include extracting the keywords and filtering the extracted keywords based on predetermined conditions. For example, the machine learning model may extract keywords from the product information associated with the first and second products and, according to a predetermined condition to filter out keywords associated with brand names, store the keywords of the first and second products excluding the brand names. The machine learning model may tokenize keywords by referencing a token dictionary stored in database 446 and implementing an Aho-Corasick algorithm to determine whether or not to split a keyword into multiple keywords. For example, keywords written in certain languages (such as Korean) may be stored as a single string of text without spaces. (A fluent speaker would understand that this string of text may be split into various combinations of words.) The machine learning model may implement an Aho-Corasick algorithm, which is a dictionary-matching algorithm that locates elements of a finite set of strings (e.g., the “dictionary”) within text associated with the first and second products. The algorithm matches all the strings simultaneously so that the machine learning model may extract keywords by collecting the actual keywords of the text while removing “split” words that are not listed in the stored dictionary. Keyword tokenization may increase product integration and deduplication by removing superfluous words that slow down the machine learning model.

Online matching model system 440 may use the machine learning model to determine a match score between the first product and each of the second products. The match score may be calculated by using the tagged keywords associated with the first product and the second products and the probability scores stored in database 446 for the trained machine learning model. The match score may be calculated using any combination of methods (e.g., Elasticsearch, Jaccard, Naïve Bayes, W-CODE, ISBN, etc.). For example, the match score may also be calculated by measuring the spelling similarities between the keywords of the first product and the keywords of the second product. In some embodiments, the match score may be calculated based on the number of shared keywords between the first product and the second product.

The machine learning model of online matching model system 440 may identify the keywords from the first and second products and use a library (e.g., fastText) to transform the keywords into vector representations. The machine learning model may use the library to learn a representation for each keyword's character n-gram. Each keyword may then be represented as a bag of character n-grams and the overall word embedding is a sum of the character n-grams. For example, an internal user or external user (e.g., user 460A) may manually set or the machine learning model may automatically set the n-gram to 3, in which case the vector for the word “where” would be represented by a sum of trigrams: <wh, whe, her, ere, re>, where the brackets <, > are boundary symbols that denote the beginning and end of a word. After each word is represented as a sum of n-grams, a latent text embedding is derived as an average of the word embedding, at which point the text embedding may be used by the machine learning model to predict the label. This process may be advantageous in identifying rare keywords or keywords that are not included in database 446. For example, the vector representations of uncommon words may have greater weight than the vector representations of more common words. The machine learning model may customize the relevance of similar keywords.

In some embodiments, online matching model system 440 may calculate the match score based on the percentage of intersecting keywords between the first and second products. For example, the match score may be calculated by dividing the number of intersecting keywords by the total number of keywords. The match score may increase with the number of intersecting keywords.

In some embodiments, online matching model system 440 may calculate the match score based on probability scores determined by the machine learning model. For example, the machine learning model may determine the probability that a keyword of the first product is related to a keyword of the second product based on shared product information (e.g., product identification number, category identification, product name, product image URL, product brand, product description, manufacturer, vendor, attributes, model number, barcode, etc.). This method of calculating the match score may be advantageous in increasing the robustness of the machine learning model in that the machine learning model requires less training data and the model may assume that each feature of a keyword is independent of any other feature of that keyword.

The machine learning model may determine that the first product is identical to one of the second products when the match score is above a predetermined threshold (e.g., the second product with the highest match score and a minimum number of matching attributes, the second product associated with the highest match score, the second product with the highest match score and a price within a certain price range, etc.). The machine learning model may modify database 446 to include data indicating that the first product is identical to the second product, thereby merging the products into a single listing and preventing product duplication. The machine learning model may determine that the first product is not any of the second products when the match scores do not meet a predetermined threshold. The machine learning model may then modify database 446 to include data indicating that the first product is not any of the second products, thereby listing the first product as a distinct new listing.

The machine learning model of online matching model system 440 may register the first product, display data indicating registration of the first product on user device 460 associated with user 460A, and update the machine learning model based on the product information associated with the first product, the product information associated with the second products, and the match scores. The machine learning model may simultaneously process a plurality of requests from a plurality of users, calculating a match score between each product of each new request and at least one product from database 446.

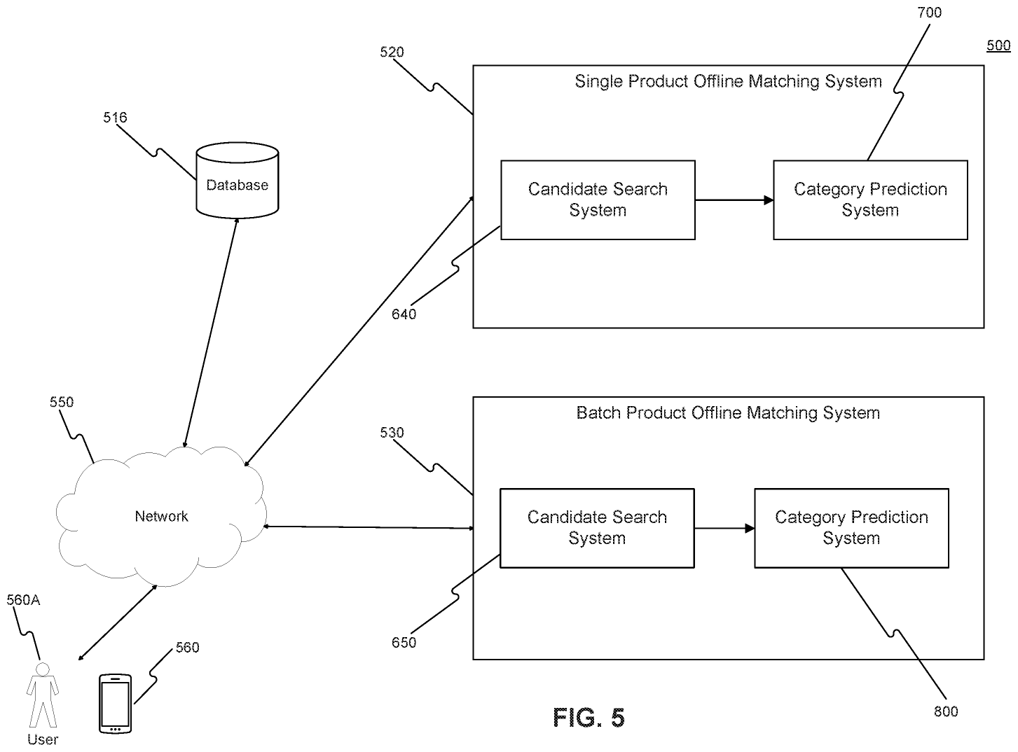

Referring to FIG. 5, a schematic block diagram illustrating an exemplary embodiment of a network comprising computerized systems for Al-based product integration and deduplication is shown. As illustrated in FIG. 5, a system 500 may include a single product offline matching system 520 and a batch product offline matching system 530, each of which may communicate with a database 516 and a user device 560 associated with a user 560A via a network 550. A matching system may operate offline when it does not operate concurrently with one or more sellers who are registering their product. In some embodiments, single product offline matching system 520 and batch product offline matching system 530 may communicate with each other and with the other components of system 500 via a direct connection, for example, using a cable. In some other embodiments, system 500 may be a part of system 100 of FIG. 1A and may communicate with the other components of system 100 (e.g., external front end system 103, internal front end system 105, or system 400) via network 550 or via a direct connection, for example, using a cable. Single product offline matching system 520 and batch product offline matching system 530 may each comprise a single computer or may each be configured as a distributed computer system including multiple computers that interoperate to perform one or more of the processes and functionalities associated with the disclosed examples.

Database 516 may store data that may be used by systems 520 and 530 for performing methods and processes associated with disclosed examples. Database 516 may be similar to the databases described above and may be in an external storage device located outside of systems 520 and 530, as shown in FIG. 5, or alternatively, it may be located in systems 520 or 530. Data stored in 516 may include any suitable data associated with products (e.g., product identification number, category identification, product name, product image URL, product brand, product description, manufacturer, vendor, attributes, model number, barcode, highest category level, category sublevels, match scores, etc.). User device 560 and user 560A may be similar to the user devices and users described above.

Offline matching systems 520 and 530 may perform steps in a manner similar to those of online matching model system 440 described above. Offline matching systems 520 and 530 may operate when online matching model system 440 is not operating. For example, offline matching systems 520 and 530 may operate periodically (e.g., daily) and independently of online matching model system 440. Online matching model system 440 may operate under a time constraint (e.g., 15 minutes) so that sellers may register new products without delay. Offline matching systems 520 and 530 may operate without time constraints, so a machine learning model, which may be the same as the machine learning model of online matching model system 440 or a different machine learning model, of offline matching systems 520 and 530 may calculate a single match score for a single pair of products or match scores for a first batch of a plurality of products and a second batch of a plurality of products. Product information associated with the products (e.g., first and second batches) may be stored in database 516. Database 516 may store the same or similar data as in databases 416, 426, 436, or 446.

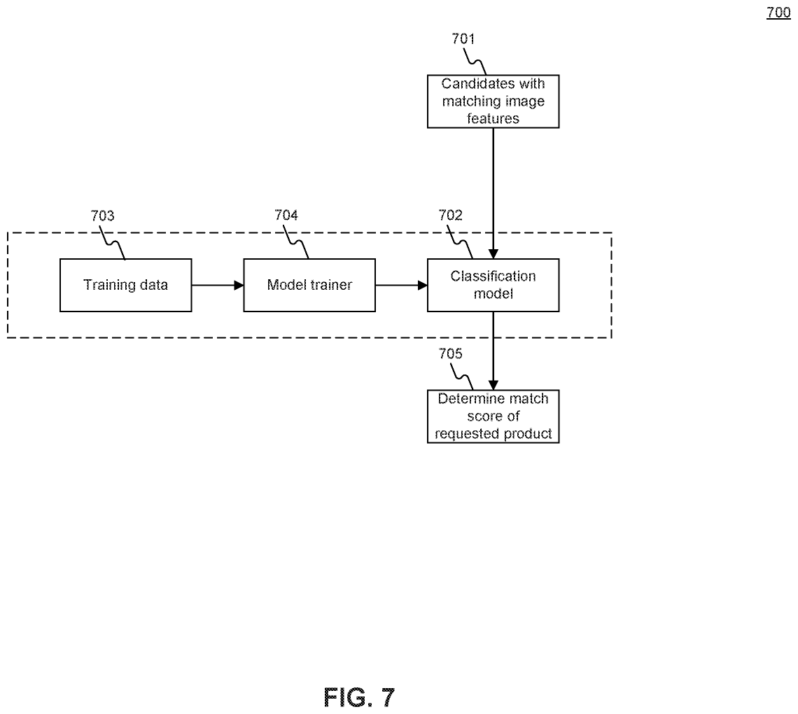

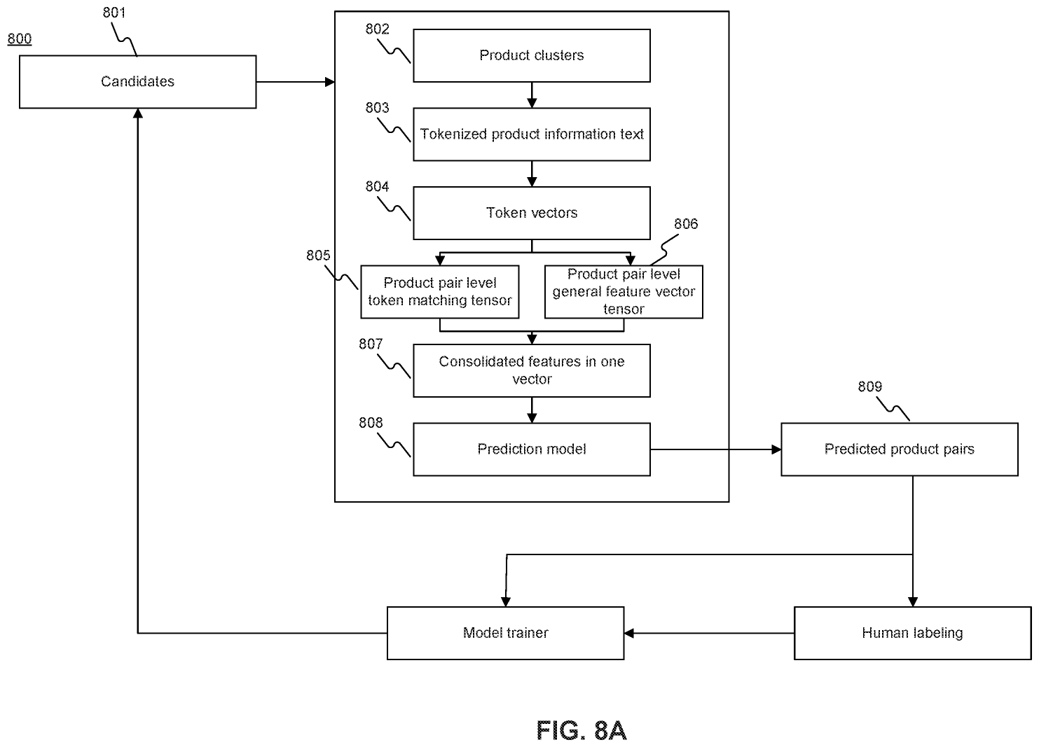

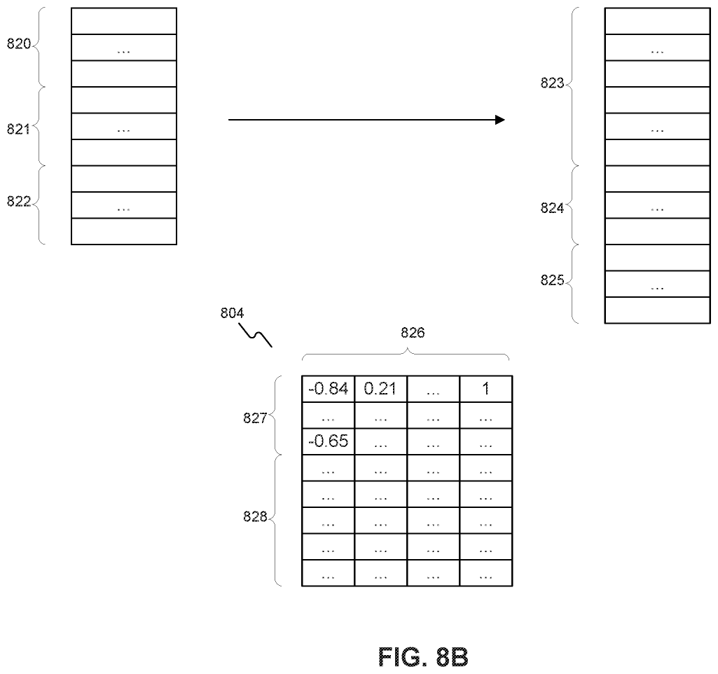

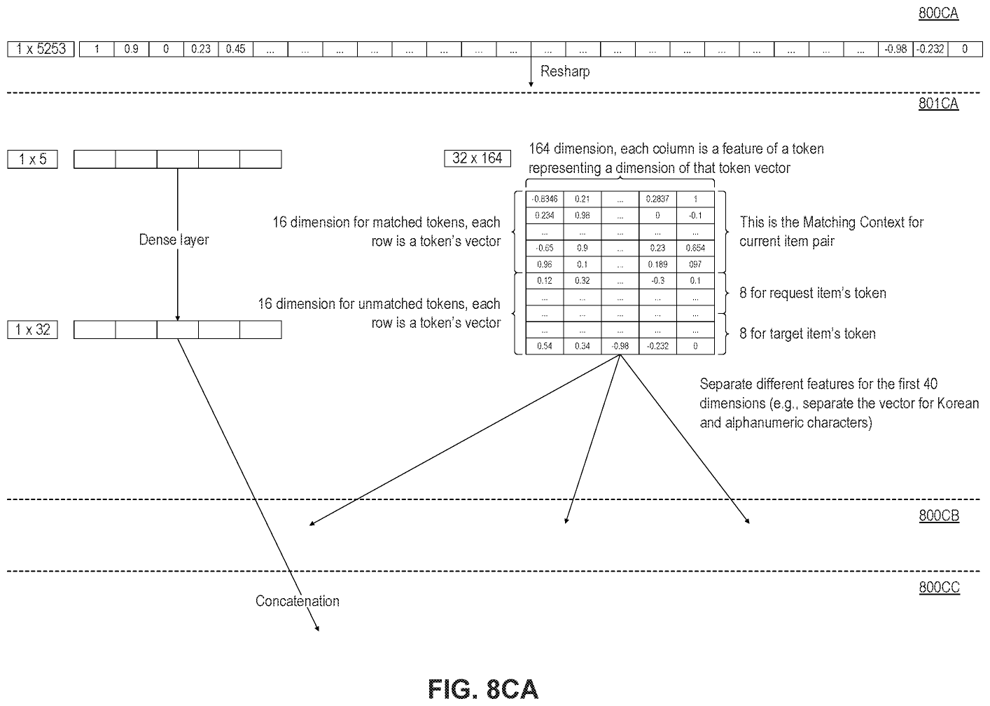

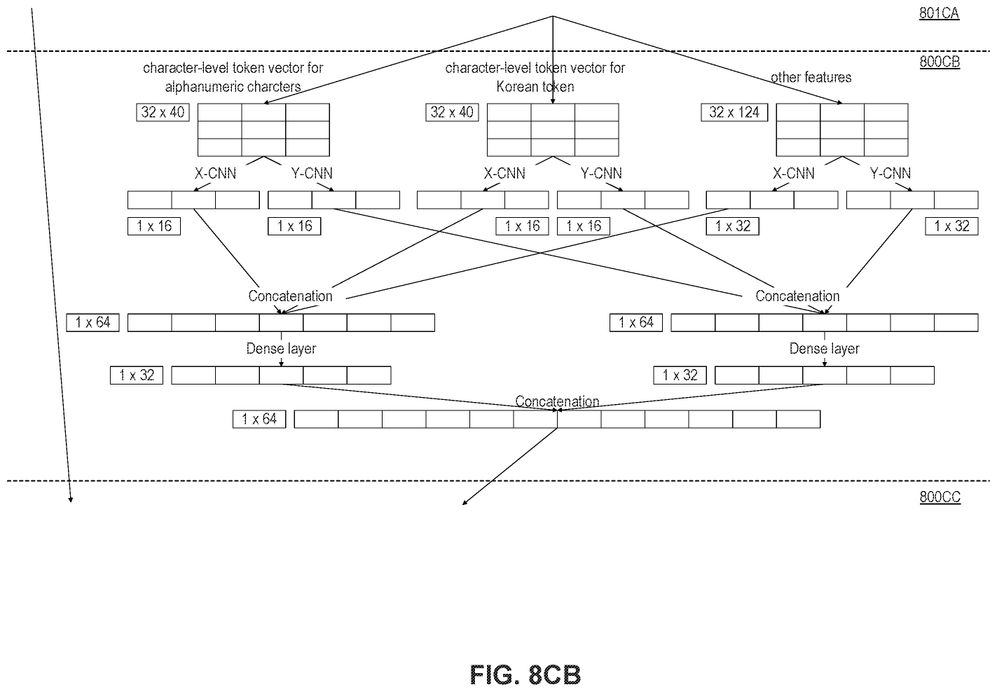

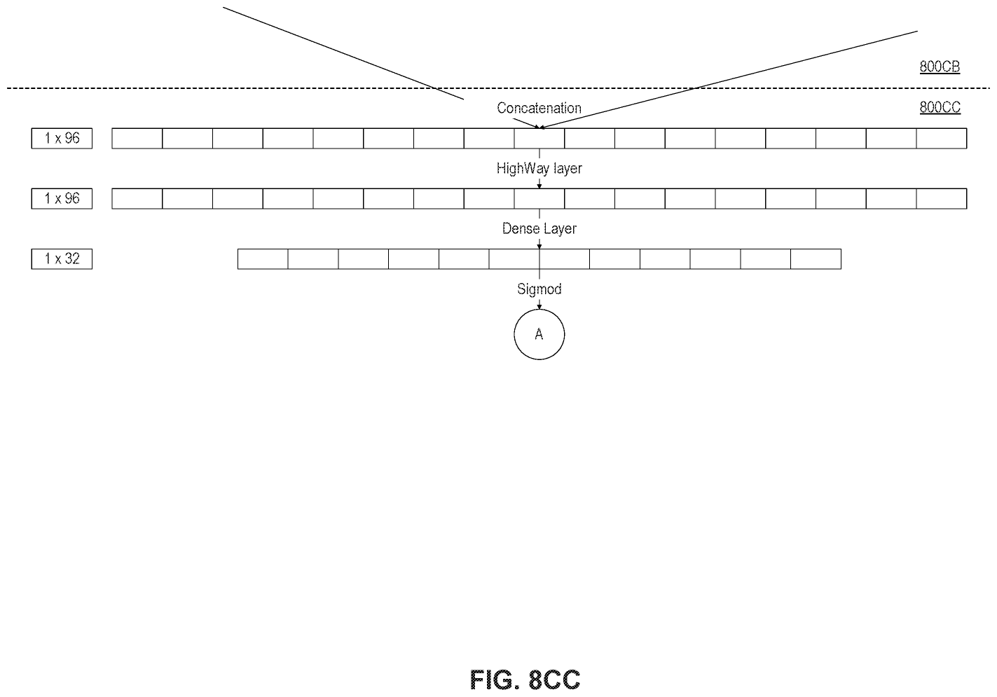

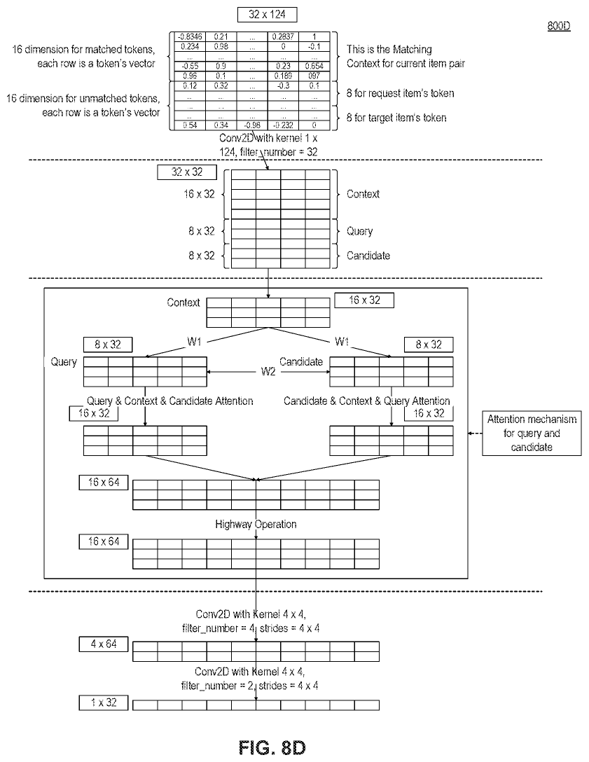

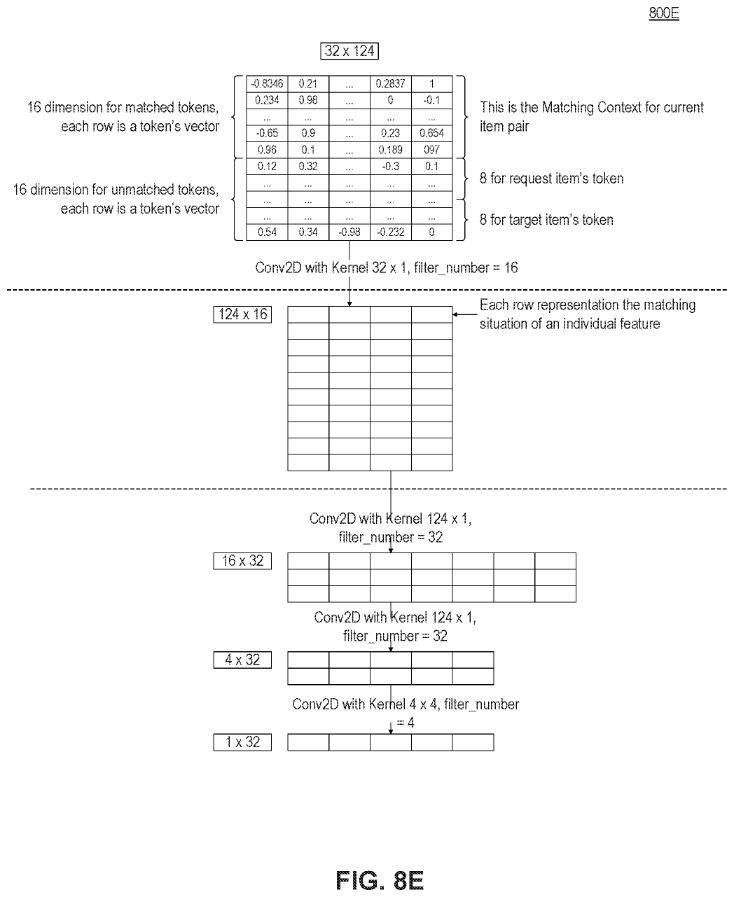

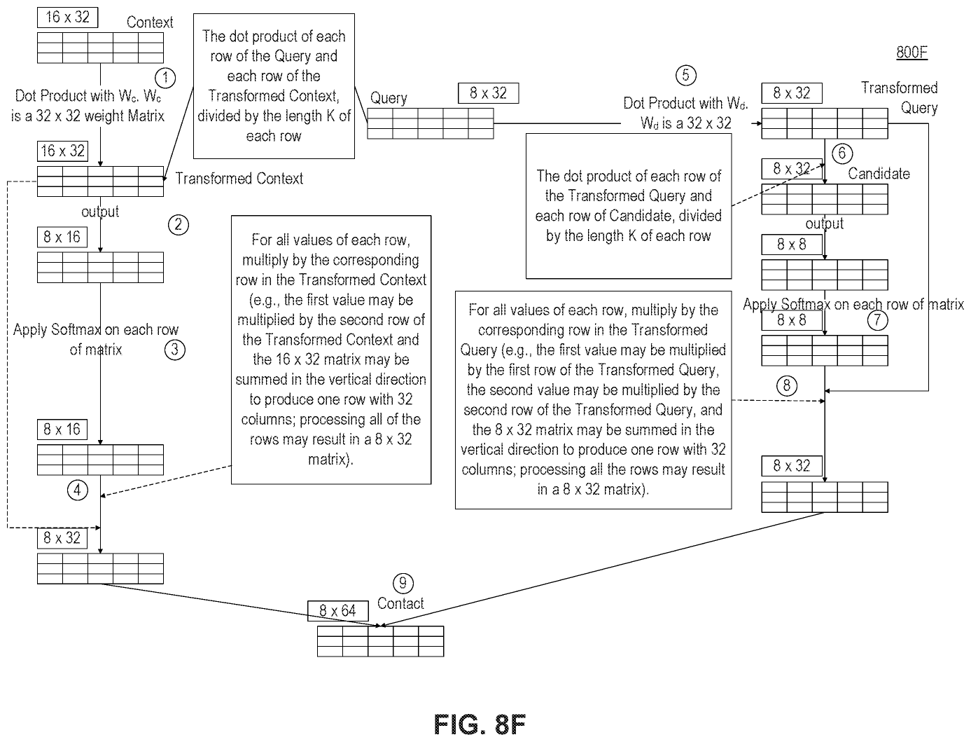

Single product offline matching system 520 may include a candidate search system 640 and a category prediction system 700 (discussed below with respect to FIG. 7). In some embodiments, candidate search system 600 may use a search engine (e.g., Elasticsearch) to generate candidates for a single product request submitted by a user (e.g., user 560A). Batch product offline matching system 530 may include a candidate search system 650 and a category prediction system 800 (discussed below with respect to FIG. 8A).

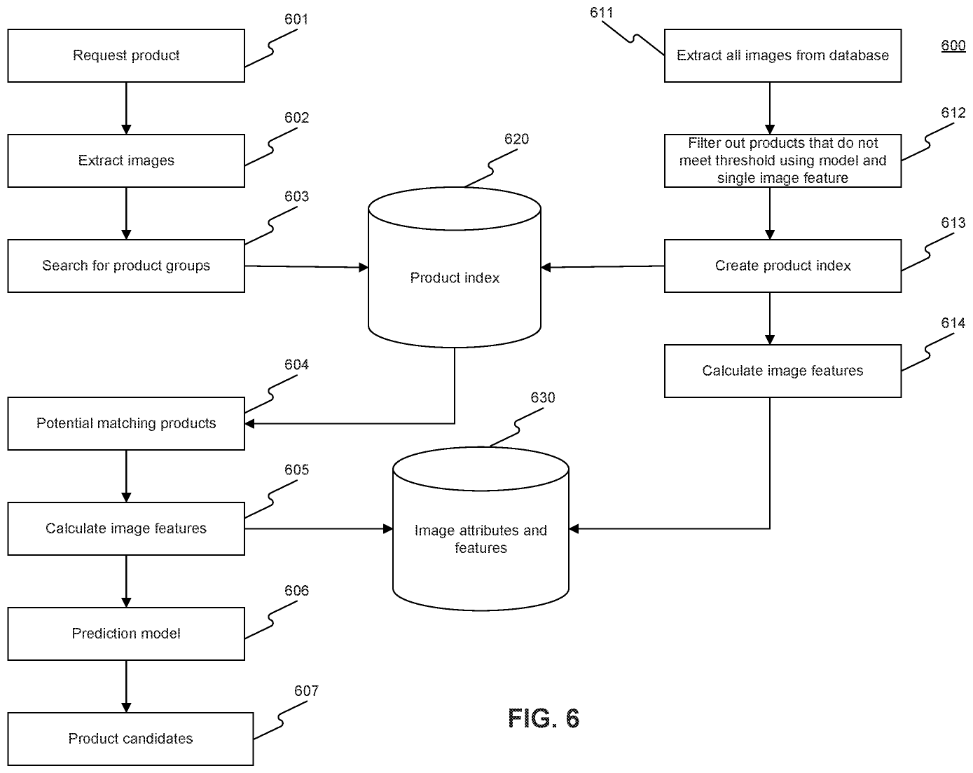

Referring to FIG. 6, a process illustrating an exemplary embodiment of candidate search systems 640 and 650 for Al-based product integration and deduplication is shown. While in some embodiments one or more of the systems depicted in FIG. 4 or FIG. 5 may perform several of the steps described herein, other implementations are possible. For example, any of the systems and components (e.g., those shown in system 100, etc.) described and illustrated herein may perform the steps described in this disclosure.

In step 601, a candidate search system 600 (e.g., candidate search systems 640 or 650) may receive one or more new requests to register one or more products from a user (e.g., user 560A via user device 560). Candidate search system 600 may receive, with the new request(s), product information data (e.g., product identification number, category identification, product name, product image URL, product brand, product description, manufacturer, vendor, attributes, model number, barcode, etc.) associated with the product(s) to be registered.

In step 602, candidate search system 600 may extract the images of the product(s) to be registered and in step 603, system 600 may search for matching products in database 620. Database 620 may be similar to databases described above and include indexed product images.

In step 611, system 600 may extract all images from existing products. In step 612, system 600 may filter out non-product images (e.g., advertisement images) using individual image features (e.g., image frequency statistics, image relevancy statistics, image position frequency statistics, image size, etc.) based on predetermined thresholds (e.g., image size, number of products with which image may be associated, etc.). In step 613, the remaining images may be indexed and stored in database 620.

In step 604, system 600 may retrieve potential matching products from database 620. In step 605, system 600 may calculate the image features of the requested product(s) and the potential matching products and store the features in database 630. Database 630 may be similar to databases described above and include image attributes and features associated with products. Similarly, in step 614, system 600 may calculate image features for the images stored in database 620 and store the image features in database 630.

Image features that may be calculated include the sum of the square distance from the center point of the image, the average of the square distance from the center point of the image, whether the image is a first image, whether the image is a center image, whether the image is a last image, or the position score (e.g., the position of the image divided by the total image count). Image features may also include the log of the image content size (e.g., image resolution), the total count of products that include an image, the total count of vendors that include an image, the content size divided by the product count, or the content size divided by the vendor count.

In step 605, matched image features may be calculated for the pair of the requested product(s) and each of the potential matching products. For example, the matched image features may include the total image count, the matched image count, the matched image percentage, the total content size, the matched content size, the matched content size percentage, or the average product price. The greater the number of matched features, the higher the likelihood that the requested product(s) and the potential matching product are the identical.

In step 606, system 600 may use a machine learning model to predict the product candidates that may match the requested product(s). System 600 may train the model using calculated features of existing products. For example, system 600 may use the sum of the matched image content size, the average image position scores, or the highest feature values to train the model. The model may be a supervised learning model (e.g., support-vector machine) with associated learning algorithms that analyze data used for classification and regression analysis. System 600 may build the model based on pairs of training data marked as identical or different, assigning new examples to one category or the other, making it a non-probabilistic binary linear classifier. The model may represent the examples as points in space, mapped so that the examples of the separate categories are divided by a clear gap that is as wide as possible. New examples are then mapped into that same space and predicted to belong to a category based on the side of the gap on which they fall. The model may efficiently perform a non-linear classification by implicitly mapping inputs into high-dimensional feature spaces.

In step 607, system 600 may send the potential product matching candidates, predicted by the model to match the requested product(s), to category prediction system 700 or to user 560A (e.g., internal employee) via user device 560. A user (e.g., user 560A) may randomly sample pairs of products and label the products as identical or different use the labeled data to retrain the model.

In some embodiments, databases 620 and 630 and steps 611-614 may operate offline and concurrently with steps 601-607.

Referring to FIG. 7, a process illustrating an exemplary embodiment of category prediction system 700 for Al-based product integration and deduplication is shown. While in some embodiments one or more of the systems depicted in FIG. 4 or FIG. 5 may perform several of the steps described herein, other implementations are possible. For example, any of the systems and components (e.g., those shown in system 100, etc.) described and illustrated herein may perform the steps described in this disclosure.

In some embodiments, classification model 702 may receive candidates 701 with matching text features or with matching image features from candidate search system 640. Training data 703 may be used to train model 702 using model trainer 704. Training data 703 may be similar to the training data of system 410 and pre-processed in a manner similar to system 520 as described above. Model trainer 704 may train model 702 in a manner similar to model trainer 430 described above.

For example, model trainer 704 may receive synthesized training data from pre-processed training data 703. System 700 may tag the keywords from a pair of products. Tagging the keywords may include extracting the keywords and filtering the extracted keywords based on predetermined conditions. For example, system 700 may extract keywords from the product information associated with the first and second products of a pair and, according to a predetermined condition to filter out keywords associated with brand names, store the keywords of the first and second products excluding the brand names. System 700 may tokenize keywords by referencing a token dictionary stored in a database (e.g., database 426) and implementing an Aho-Corasick algorithm to determine whether or not to split a keyword into multiple keywords. For example, keywords written in certain languages (such as Korean) may be stored as a single string of text without spaces. (A fluent speaker would understand that this string of text may be split into various combinations of words.) System 700 may implement an Aho-Corasick algorithm, which is a dictionary-matching algorithm that locates elements of a finite set of strings (e.g., the “dictionary”) within text associated with the first and second products. The algorithm matches all the strings simultaneously so that system 700 may extract keywords by collecting the actual keywords of the text while removing “split” words that are not listed in the stored dictionary. Keyword tokenization may increase product integration and deduplication by removing superfluous words that slow down the machine learning model.

System 700 may process the keywords of the first product using any combination of methods. For example, system 700 may perform a stemming process on each keyword by reducing each keyword to its root word. For example, the words “rain,” “raining,” and “rainfall” have the common root word “rain.” When the keyword is indexed, the root word is stored into the index, thereby increasing the search relevance of the keywords. The keywords stored in the database are indexed stemmed keywords. Additionally, system 700 may perform a synonym search on each keyword, thereby improving the keyword search quality.

Classification model 702 may determine a match score 705 (e.g., match score of system 400) with of the requested product with candidates 701 above a predetermined threshold. Although classification model 702 is depicted as a single model that may learn and predict for all product categories, classification model 702 may include a plurality of models, where each model is trained for a different product category. Classification model 702 may provide a gradient boosting framework (e.g., XGBoost, CatBoost, etc.) that for regression and classification problems, which produces a prediction model in the form of an ensemble of weak prediction models (e.g., decision trees). System 700 may build model 702 in a stage-wise manner and generalize the model by allowing optimization of an arbitrary differentiable loss function.

System 700 may determine whether the requested product is identical to an existing product based on match score 705. If match score 705 of the requested product is above a predetermined threshold, then system 700 may determine that the requested product is identical to an existing product and should be merged with that product's listing. If match score 705 of the requested product is below a predetermined threshold, then system 700 may determine that the requested product is different from any existing products and proceed with listing the requested product as a new registered product.

Referring to FIG. 8A, a process illustrating an exemplary embodiment of category prediction system 800 for Al-based product integration and deduplication is shown. While in some embodiments one or more of the systems depicted in FIG. 4 or FIG. 5 may perform several of the steps described herein, other implementations are possible. For example, any of the systems and components (e.g., those shown in system 100, etc.) described and illustrated herein may perform the steps described in this disclosure.

System 800 may receive candidates 801 from candidate search system 650 and construct product clusters 802. The products in each cluster 802 may be similar (e.g., share at least one product image). System 800 may the tokenize product clusters 802 in a manner similar to tokenization described above.

System 800 may then calculate token vectors 804. Each feature may represent a dimension for a token vector 804. Features may include characters (e.g., “a”, “b”, “c”, etc.), contexts (e.g., foreign, group score of token in product cluster, position score, percentage of existing products that contain a token, character placement, number of different vendors involved in an alphanumeric namespace, alphanumeric namespace confidence score), format (e.g., banned product, age range, gender, clothing size, floating number, digit, alphanumeric digit, English words, Korean words, word length, weight, length, volume, quantity, etc.), statistics (e.g., is token from exposed attributes for requested products, number of times token is used in exposed attributes, number of vendors who have this token, number of products that have this token, number of categories that have this token, where token appears most, percentage of tokens in exposed attributes, etc.), location (e.g., how often is token in brand field, model number field, search tags, manufacturing field, SKU field, barcode field, CQI brand field, color field, etc.), statistics rate (e.g., increase velocity of global exposed count, increase velocity of average full position score, etc.), statistics relative rate (e.g., average global token count of all tokens of a product, minimum global token count of all tokens of a product, etc.), or general product pair level feature (e.g., normalized product identification gap, sales price difference, total product count of product cluster, percentage of shared Korean text, etc.).

Referring to FIG. 8B, a process illustrating an exemplary embodiment of calculating token vectors 804 for Al-based product integration and deduplication is shown.

As shown in FIG. 8B, cells 820 may represent seven matched tokens from both the requested products and the candidate products, cells 821 may represent ten unmatched tokens from a requested product, and cells 822 may represent five unmatched tokens from one of the candidate products. Cells 823 may represent the top sixteen tokens that match between the requested product and the candidate product. Cells 823 may include “NULL” cells if less than sixteen tokens match. Cells 824 may represent the top eight unmatched tokens from the requested product and cells 825 may represent the top eight unmatched tokens from the candidate product. Cells 824 and 825 may include “NULL” cells if less than eight tokens are unmatched.

System 800 may calculate 16×164 token vector 804. Cells 826 may include 164 dimensions where each dimension represents one token's feature. Cells 827 may represent dimensions for matched tokens where each row is a token's vector. Cells 828 may represent dimensions for unmatched tokens where each row is a token's vector. Cells 827 and 828 may be ordered by predetermined rules so that similar tokens are located in approximately the same position. System 800 may flatten and pre-append the general item pair level features of token vector 804 to calculate a 1×5253 dimensions vector.

Referring back to FIG. 8A, system 800 may compose product pair level token matching tensors 805 and product pair level general feature vector tensors 806.

Referring to FIGS. 8CA, 8CB, 8CC, 8D, 8E, and 8F, processes illustrating exemplary embodiments of consolidating features into one vector 807 for Al-based product integration and deduplication is shown.

FIGS. 8CA, 8CB, and 8CC may include processes 800CA, 801CA, 800CB, and 800CC. FIGS. 8D, 8E, and 8F may include processes 800D, 800E, and 800F, respectively. As shown in FIGS. 8CA, 8CB, 8CC, and 8D, tensors 805 may have a query-context attention for focusing on important tokens. The first layer of 805 may use a convolution layer with kernel 1×124 and may embed the token vector into more dense vectors. System 800 may use a customized query-context attention layer to find the important tokens for the requested and candidate products' unmatched tokens. System 800 may use a highway layer to adjust the importance of the requested and candidate products' attention results, using more convolution layers to product a final one-dimension output.

For example, in process 800CA, system 800 may resharpen a dimensions vector (e.g., 1×5253 dimensions vector of FIG. 8B) into two token vectors (e.g., one 1×5 vector and one 32×164 vector). In process 801CA, system 800 may embed one token vector into a dense vector (e.g., 1×32 vector). In process 801CA, system 800 may calculate a token vector (e.g., 32×164 vector) that may include a dimension (e.g., 164 dimension) where each column of the token vector is a feature of a token representing a dimension of the token vector. The token vector may include a dimension for matched tokens (e.g., 16 dimension) with a matching context for a pair of products where each row is a token's vector. The token vector may also include a dimension for unmatched tokens (e.g., 16 dimension) with a dimension for the requested product's token (e.g., 8 dimension) and a dimension for a candidate product's token (e.g., 8 dimension), where each row is a token's vector.

In process 800CB, system 800 may include a x-direction convolutional neural network (X-CNN) and a y-direction convolutional neural network (Y-CNN). The X-CNN may include a query-context attention for focusing on important tokens on the token vector level. The X-CNN may include a first convolution layer with a big kernel (e.g., 1×124) that may embed the token vector into more dense vectors. The X-CNN may use a customized query-context attention layer to find the important tokens it should focus on for the requested product and candidate products' unmatched tokens.

The Y-CNN may focus on important features for feature level matching. In process 800CB, system 800 may use convolution layers with big kernels (e.g., 32×1, 124×1) in they direction. The first two convolution layers may have large kernel sizes (e.g., 32×1, 124×1) while the other layers may have small kernel sizes (e.g., 2×2, 3×3, 4×4, etc.). The Y-CNN may use a customized query-context attention layer to find the important tokens it should focus on for the requested product and candidate products' unmatched tokens. In process 800CC, system 800 may calculate a combined vector using the results of the X-CNN and the Y-CNN. System 800 may use a highway layer to adjust the importance of the query-context attention results and use more convolutional layers to calculate a final 1-dimensional output.

Processes 800D and 800E may include processes that operate in a manner similar to processes 800CA, 801CA, 800CB, and 800CC described above. As shown in FIG. 8E, tensors 806 may focus on the important features by using convolutions layers with big kernels (e.g., 32×1, 124×1) in the vertical (e.g., y) direction. The first two convolutional layers may have big kernels while the other layers may have small kernels (e.g., 2×2, 3×3, 4×4, etc.).

As shown in FIG. 8F, system 800 may implement query-context attention by using weight matrices We and Wo for attention and weight matrices WG and WT for a gating mechanism in process 800F. As shown in FIG. 8F, system 800 may calculate the dot product of a context matrix (e.g., 16×32) with weight matrix We (e.g., 32×32) to output a transformed context matrix (e.g., 16×32). System 800 may calculate the dot product of each row of the query (e.g., requested product) matrix (e.g., 8×32) and each row of the transformed context matrix and divide by the length “K” of each row to output a matrix (e.g., 8×16). System 800 may apply softmax on each row of the matrix. System 800 may, for all values of each row of the matrix, multiply by the corresponding row in the transformed context matrix. For example, the first value may be multiplied by the second row of the transformed context matrix and the context matrix may be summed in the vertical direction to produce one row (e.g., with 32 columns). Processing all of the rows may result in a new matrix (e.g., 8×32).

In process 800F, system 800 may calculate the dot product of the query matrix with matrix W_{d} (e.g., 32×32) to output a transformed query matrix (e.g., 8×32). System 800 may calculate the dot product of each row of the transformed query matrix and each row of the candidate matrix and divide by the length “K” of each row to output a new matrix (e.g., 8×8). System 800 may apply softmax on each row of the matrix. System 800 may, for all values of each row, multiply by the corresponding row in the transformed query matrix. For example, the first value may be multiplied by the first row of the transformed context matrix and the second value may be multiplied by the second row of the transformed query matrix and the matrix (e.g., 8×32) may be summed in the vertical direction to produce one row (e.g., with 32 columns). Processing all the rows may result in a new matrix (e.g., 8×32). System 800 may combine the processed transformed context matrix with the processed transformed query matrix to output a single matrix (e.g., 8×64). System 800 may add an additional gate layer to adjust the weights in the single matrix.

Referring back to FIG. 8A, prediction model 808 may determine match scores between a plurality of requested products and a plurality of candidate products based on consolidated vector 807. System 800 may determine predicted product pair 809 based on match scores that are above predetermined thresholds. System 800 may determine whether requested products are identical to existing products based on the match scores. If match scores are above a predetermined threshold, then system 800 may determine that the requested product is identical to an existing product and should be merged with that product's listing. If match scores are below a predetermined threshold, then system 800 may determine that the requested product is different from any existing products and proceed with listing the requested product as a new registered product.

In some embodiments, unlike online matching model system 440, offline matching systems 520 and 530 may use more expensive calculation logic (e.g., gradient boosting, convolutional neural network, etc.) since it may operate without time constraints. Similar to online matching model system 440 described above, the machine learning model of offline matching system 420 may tag a plurality of keywords from product information associated with the first and second batches of products and determine a plurality of match scores between any combination of the first and second batches of products. The match scores may be calculated using the tagged keywords, as described above for online matching system 410. The machine learning model may determine that products associated with a match score are identical when the match score is above a predetermined threshold (as described above for online matching system 410). The machine learning model may remove a first identical product from its associated listing and add that first identical product to a listing associated with a second identical product in order to integrate and deduplicate the products. The machine learning model may perform these steps simultaneously for any number or combination of products.

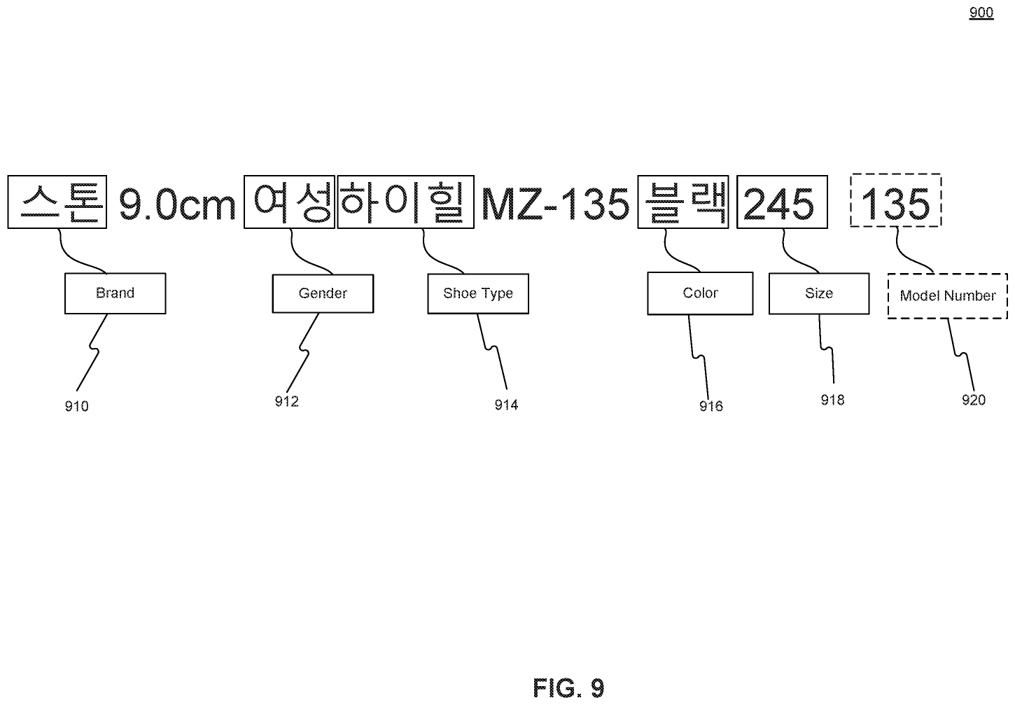

Referring to FIG. 9, sample tagged data 900 for Al-based product integration and deduplication is shown. A system (e.g., system 100, system 400, system 500, etc.) may extract keywords associated with the brand 910, gender 912, shoe type 914, color 916, size 918, and model number 920 of a product. The system may filter out keywords associated with model number 920 according to a predetermined condition to filter out keywords associated with model numbers. Extracted keywords 910, 912, 914, 916, and 918 may be used for product integration and deduplication. The particular keywords depicted in FIG. 9 are exemplary; more, fewer, or other keywords may be used in different embodiments.

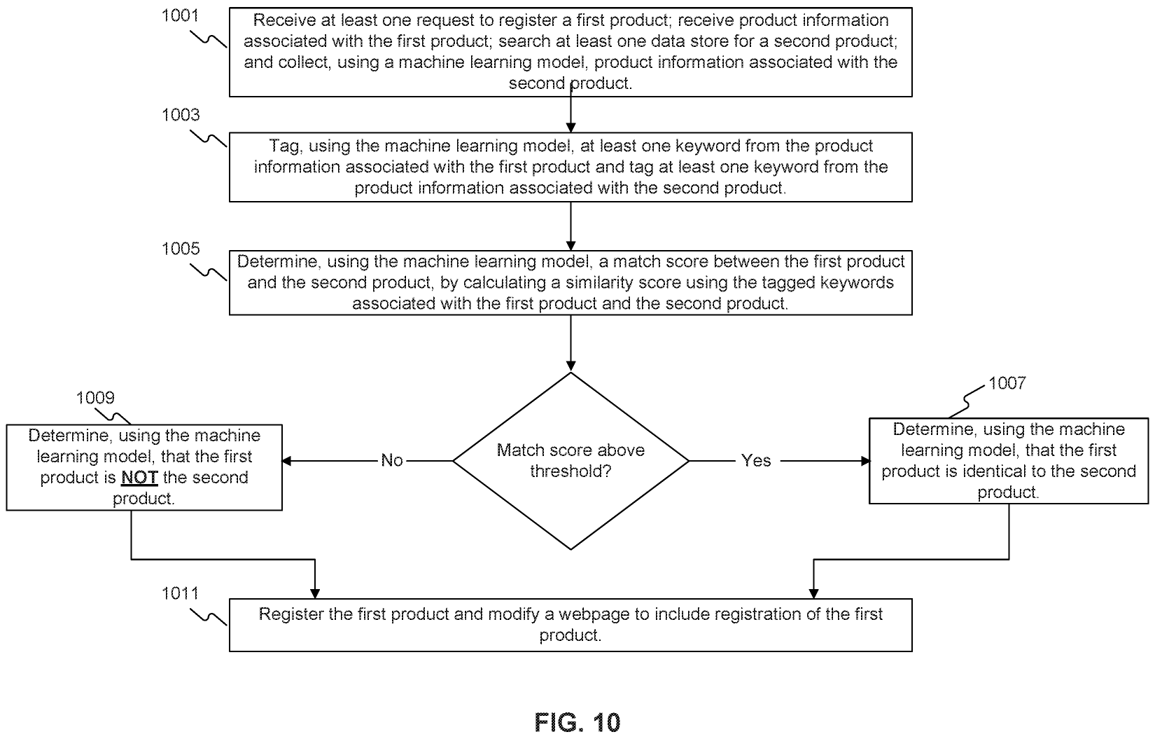

Referring to FIG. 10, a process for integrating and deduplicating products using Al is shown. While in some embodiments one or more of the systems depicted in FIG. 4 or 5 may perform several of the steps described herein, other implementations are possible. For example, any of the systems and components (e.g., those shown in system 100, etc.) described and illustrated herein may perform the steps described in this disclosure.

In step 1001, system 400 may receive at least one new request to register a first product from user 460A via user device 460. System 400 may receive, with the new request, product information data (e.g., product identification number, category identification, product name, product image URL, product brand, product description, manufacturer, vendor, attributes, model number, barcode, etc.) associated with the first product to be registered. System 400 may search database 446 for a second product using keywords from the product information data associated with the first product. System 400 may then determine that at least one second product (e.g., 100 second products) in database 446 may be similar to the first product based on shared or similar keywords of the first and second products. A machine learning model of system 400 may collect product information (e.g., product identification number, category identification, product name, product image URL, product brand, product description, manufacturer, vendor, attributes, model number, barcode, etc.) associated with the at least one second product. The second products in database 446 may be products that are currently registered with at least one seller.

In step 1003, the machine learning model may then tag the keywords from the first and second products. Tagging the keywords may include extracting the keywords and filtering the extracted keywords based on predetermined conditions. For example, the machine learning model may extract keywords from the product information associated with the first and second products and, according to a predetermined condition to filter out keywords associated with brand names, store the keywords of the first and second products excluding the brand names.

In step 1005, the machine learning model may determine a match score between the first product and each of the second products. The match score may be determined by using the tagged keywords associated with the first product and the second products. The match score may be calculated using any combination of methods (e.g., Elasticsearch, Jaccard, naïve Bayes, W-CODE, ISBN, etc.). For example, the match score may be calculated by measuring the spelling similarities between the keywords of the first product and the keywords of the second product. In some embodiments, the match score may be calculated based on the number of shared keywords between the first product and the second product.

In step 1007, the machine learning model may determine that the first product is identical to one of the second products when the match score is above a predetermined threshold (e.g., the second product with the highest match score and a minimum number of matching attributes, the second product associated with the highest match score, the second product with the highest match score and a price within a certain price range, etc.). The machine learning model may modify database 446 to include data indicating that the first product is identical to the second product, thereby merging the products into a single listing and preventing product duplication.

In step 1009, the machine learning model may determine that the first product is not any of the second products when the match scores do not meet a predetermined threshold. The machine learning model may then modify database 446 to include data indicating that the first product is not any of the second products, thereby listing the first product as a distinct new listing.

In step 1011, the machine learning model may then register the first product, modify a webpage indicating registration of the first product, and update the machine learning model based on the product information associated with the first product, the product information associated with the second products, and the match scores.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for Al-based product integration and deduplication, the system comprising:
a memory storing instructions; and
at least one processor configured to execute the instructions to:
receive at least one request to register a first product;
receive product information associated with the first product;
search at least one data store for a second product;
collect, using a machine learning model, product information associated with the second product;
tag, using the machine learning model, at least one keyword from the product information associated with the first product and tag at least one keyword from the product information associated with the second product,
wherein the tagging comprises extracting at least one keyword from the product information associated with the first and second products and filtering the extracted keywords based on predetermined conditions;
transform, using the machine learning model, the tagged keywords into vector representations, wherein the vector representations are associated with alphanumeric characters of the tagged keywords;
assign, using the machine learning model, different weights to the vector representations based on categorizations of the tagged keywords;
extract a plurality of images from the product information associated with the first product and the product information associated with the second product;
filter non-product images from the plurality of images based on at least one of image frequency statistics, image relevancy statistics, or image position frequency statistics;
determine, using the machine learning model, a plurality of image features of the filtered plurality of images;
determine, using the machine learning model, a match score between the first product and the second product, by using the weighted vector representations of the tagged keywords associated with the first product and the second product and the plurality of image features, wherein:
calculating the match score by the machine learning model comprises:
determining a probability that a tagged keyword associated with the first product is related to a tagged keyword associated with the second product; and
determining a probability that at least one image feature associated with the first product is related to at least one image feature associated with the second product;
when the match score is above a first predetermined threshold, determine, using the machine learning model, that the first product is identical to the second product and modify the at least one data store to include data indicating that the first product is identical to the second product;
when the match score is below a first predetermined threshold, determine, using the machine learning model, that the first product is not the second product and modify the at least one data store to include data indicating that the first product is not the second product;
register the first product; and
modify a webpage to include registration of the first product.

2. The system of claim 1, wherein the product information associated with the first product and the product information associated with the second product comprises at least one of a manufacturer, vendor, product name, brand, price, image URL, model number, or category identification.

3. The system of claim 1, wherein the product information associated with the first product shares at least one product information data with the product information associated with the second product.

4. (canceled)

5. The system of claim 1, wherein extracting comprises tokenizing at least one keyword.

6. The system of claim 1, wherein calculating the match score is based on spelling of the keywords.

7. The system of claim 1, wherein calculating the match score is based on a number of keywords shared by the first and second products.

8. The system of claim 1, wherein determining the probability comprises calculating a probability score associated with the first product and calculating a probability score associated with the second product.

9. The system of claim 1, wherein the at least one processor is further configured to execute the instructions to update the machine learning model based on the product information associated with the first product, the product information associated with the second product, and the match score.

10. A method integrating and deduplicating products using Al, the method comprising:
receiving at least one request to register a first product;
receiving product information associated with the first product;
searching at least one data store for a second product;
collecting, using a machine learning model, product information associated with the second product;
tagging, using the machine learning model, at least one keyword from the product information associated with the first product and tagging at least one keyword from the product information associated with the second product,
wherein the tagging comprises extracting at least one keyword from the product information associated with the first and second products and filtering the extracted keywords based on predetermined conditions;
transforming, using the machine learning model, the tagged keywords into vector representations, wherein the vector representations are associated with alphanumeric characters of the tagged keywords;
assigning, using the machine learning model, different weights to the vector representations based on categorizations of the tagged keywords;
extract a plurality of images from the product information associated with the first product and the product information associated with the second product;
filter non-product images from the plurality of images based on at least one of image frequency statistics, image relevancy statistics, or image position frequency statistics;
determine, using the machine learning model, a plurality of image features of the filtered plurality of images;
determining, using the machine learning model, a match score between the first product and the second product, by using the weighted vector representations of the tagged keywords associated with the first product and the second product and the plurality of image features, wherein:
calculating the match score by the machine learning model comprises:
determining a probability that a tagged keyword associated with the first product is related to a tagged keyword associated with the second product; and
determining a probability that at least one image feature associated with the first product is related to at least one image feature associated with the second product;
when the match score is above a first predetermined threshold, determining, using the machine learning model, that the first product is identical to the second product and modifying the at least one data store to include data indicating that the first product is identical to the second product;
when the match score is below a first predetermined threshold, determining, using the machine learning model, that the first product is not the second product and modifying the at least one data store to include data indicating that the first product is not the second product;
registering the first product; and
modifying a webpage to include registration of the first product.

11. The method of claim 10, wherein the product information associated with the first product and the product information associated with the second product comprises at least one of a manufacturer, vendor, product name, brand, price, image URL, model number, or category identification.

12. The method of claim 10, wherein the product information associated with the first product shares at least one product information data with the product information associated with the second product.

13. (canceled)

14. The method of claim 10, wherein extracting comprises tokenizing at least one keyword.

15. The method of claim 10, wherein calculating the match score is based on spelling of the keywords.

16. The method of claim 10, wherein calculating the match score is based on a number of keywords shared by the first and second products.

17. The method of claim 10, wherein determining the probability comprises calculating a probability score associated with the first product and calculating a probability score associated with the second product.

18. The method of claim 10, further comprising updating the machine learning model based on the product information associated with the first product, the product information associated with the second product, and the match score.

19. A computer-implemented system for Al-based product integration and deduplication, the system comprising:
a memory storing instructions; and
at least one processor configured to execute the instructions to:
receive at least one request to register a first product;
receive product information associated with the first product;
search at least one data store for a second product;
collect, using a first machine learning model, product information associated with the second product;
tag, using the first machine learning model, at least one keyword from the product information associated with the first product and tag at least one keyword from the product information associated with the second product,
wherein the tagging comprises extracting at least one keyword from the product information associated with the first and second products and filtering the extracted keywords based on predetermined conditions;
transform, using the first machine learning model, the tagged keywords into vector representations, wherein the vector representations are associated with alphanumeric characters of the tagged keywords;
assign, using the machine learning model, different weights to the vector representations based on categorizations of the tagged keywords;
extract a plurality of images from the product information associated with the first product and the product information associated with the second product;
filter non-product images from the plurality of images based on at least one of image frequency statistics, image relevancy statistics, or image position frequency statistics;
determine, using the machine learning model, a plurality of image features of the filtered plurality of images;
determine, using the first machine learning model, a first match score between the first product and the second product, by calculating a first similarity score using the weighted vector representations of the tagged keywords associated with the first product and the second product and the plurality of image features, wherein:
calculating the match score by the machine learning model comprises:
determining a probability that a tagged keyword associated with the first product is related to a tagged keyword associated with the second product; and
determining a probability that at least one image feature associated with the first product is related to at least one image feature associated with the second product;
when the first match score is above a first predetermined threshold, determine, using the first machine learning model, that the first product is identical to the second product and modify the at least one data store to include data indicating that the first product is identical to the second product;
when the first match score is below a first predetermined threshold, determine, using the first machine learning model, that the first product is not the second product and modify the at least one data store to include data indicating that the first product is not the second product;
register the first product;
modify a webpage to include registration of the first product;
collect, using a second machine learning model, product information associated with a plurality of third products;
tag, using the second machine learning model, a plurality of keywords from product information associated with the plurality of third products;
determine, using the second machine learning model, a plurality of second match scores between the plurality of third products, by using the tagged keywords associated with the plurality of third products;
when any one of the plurality of second match scores is above the first predetermined threshold, determine, using the second machine learning model, that the third products associated with the second match score are identical and deduplicate the identical third products; and
modify the webpage to include deduplication of the identical third products.

20. The system of claim 19, wherein deduplication comprises:
removing a first identical third product from its associated listing; and
adding the first identical third product to a listing associated with a second identical third product.
